(19) United States
(12) Patent Application Publication
(10) Pub. No.: US 2009/0187465 A1
(43) Pub. Date: Jul. 23, 2009

(54) SYSTEM AND METHOD FOR PRESENTING SUPPLEMENTAL INFORMATION IN WEB AD

(75) Inventors: Chris Leggetter, Belmonth, CA (US); Su-Lin Wu, San Carlos, CA (US)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 12/017,828

(22) Filed: Jan. 22, 2008

(51) Int. Cl. G06F 17/00; G06Q 30/00

(52) U.S. Cl. 705/10; 705/14

(57) ABSTRACT

A system for generating supplemental advertisement information. The system includes an advertisement engine and a user server. The advertisement engine is configured to select advertisements for a web page based on advertisement criteria. The user server is in communication with the advertisement engine to provide user identification information allowing the advertisement engine to access supplemental advertisement information based on the user identification.

### BACKGROUND

1. Field of the Invention

The present invention generally relates to a system and method for generating supplemental advertisement information.

2. Description of Related Art

One form of revenue for search engines and content providers are advertisements that are displayed on the pages of the websites. These advertisements may take the form of banner advertisements, advertisement lists, or other commonly known advertisements. Currently when viewing ad listings on web pages or web search result pages the user only has advertiser supplied information available to decide whether to click on the ad. The advertiser supplied information includes for example, title, abstract, and destination link. Inherently, trust or reputation of the advertiser plays a big role in the decision whether to click on an ad or not. However, before purchasing a product, users may want to get information from other sources, since the advertiser may present only information that shows their product in the best possible light.

As such a need exists for an advertisement system that provides unbiased information that generates confidence in users.

### SUMMARY

In satisfying the above need, as well as overcoming the drawbacks and other limitations of the related art, the invention provides a system and method for generating supplemental advertisement information.

The system includes an advertisement engine and a user server. The advertisement engine is configured to select advertisements for a web page based on advertisement criteria. The user server is in communication with the advertisement engine to provide user identification information allowing the advertisement engine to access supplemental advertisement information based on the user identification.

The supplemental information may include rating information about a product or service of the advertisement. The supplemental information may be retrieved from a social networking engine, a third party database, or a web search engine. In addition, the supplemental information is optionally displayed based on the user's preference, the advertiser's preference, or the preferences of an associated user.

By providing the user supplemental information that generates a higher trust factor for the user, the user can be more confident in the information provided. This allows the user to feel they have a more informed basis for clicking through an advertisement to the destination page. Such information can be customized to the user or the user's intent. One of the most trusted sources for information is friends and family of the user, so one embodiment of the system incorporates information from a social graph or network.

Adding supplemental information next to advertiser listings gives the user more (non-advertiser supplied) feedback about the advertiser or product. This information would help the user assess the quality of the listing and relevance to their intent. If the information is positive the user would be encouraged to click through to the advertiser site. This would reduce the number of poor non-converting clicks to an advertiser, and encourage users to click to sites they are more likely to engage with. In turn, this leads to higher user satisfaction and higher advertiser satisfaction, which will lead to higher advertising revenues.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of an exemplary system for generating supplemental information for an advertisement;

FIG. 2 is an image of an exemplary search web page; and

FIG. 3 is a flowchart illustrating a method for generating supplemental information for an advertisement.

### DETAILED DESCRIPTION

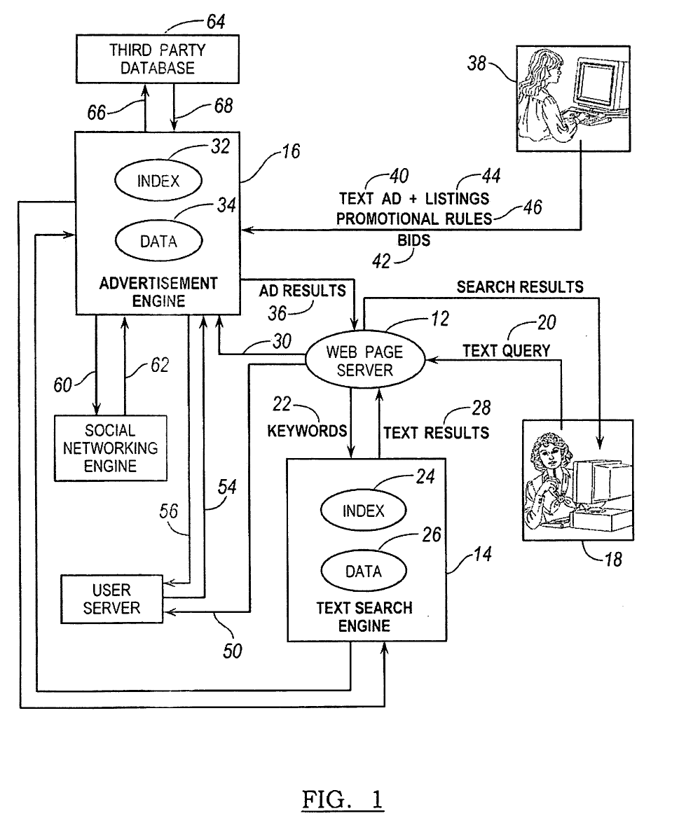

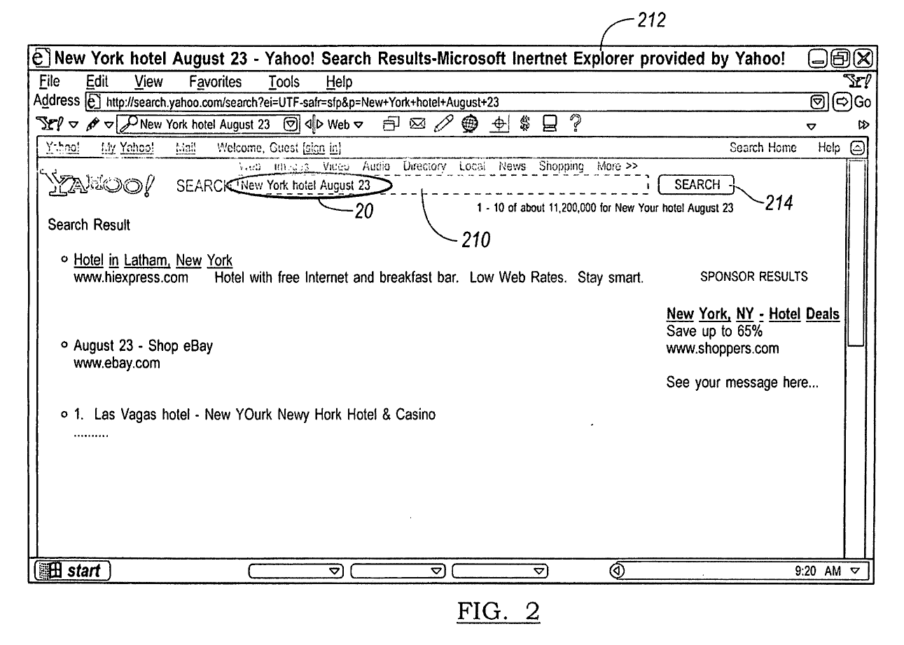

FIG. 1 shows a system 10, according to one embodiment, which includes a webpage server 12 and an advertisement engine 16. The webpage server 12 is in communication with a user system 18 over a network connection, for example over an Internet connection. In the case of a web search page, the webpage server 12 is configured to receive a text query 20 to initiate a web page search. The text query 20 may be a simple text string including one or more keywords that identify the subject matter for which the user wishes to search. For example, the text query 20 may be entered into a text box 210 located at the top of the web page 212, as shown in FIG. 2. In the example shown, five keywords “New York hotel August 23” have been entered into the text box 210 and together form the text query 20. In addition, a search button 214 may be provided. Upon selection of the search button 214, the text query 20 may be sent from the user system 18 to the webpage server 12. The text query 20 also referred to as a raw user query, may be simply a list of terms known as keywords.

Referring again to FIG. 1, the webpage server 12 provides the text query 20, to the text search engine 14 as denoted by line 22. The text search engine 14 includes an index module 24 and the data module 26. The text search engine 14 compares the keywords 22 to information in the index module 24 to determine the correlation of each index entry relative to the keywords 22 provided from the webpage server 12. The text search engine 14 then generates text search results by ordering the index entries into a list via a ranking function, for example from the highest correlating entries to the lowest correlating entries. The text search engine 14 may then access data entries from the data module 26 that correspond to each index entry in the list. Accordingly, the text search engine 14 may generate text search results 28 by merging the corresponding data entries with a list of index entries. The text search results 28 are then provided to the webpage server 12 to be formatted and displayed to the user.

The webpage server 12 is also in communication with the advertisement engine 16 allowing the webpage server 12 to tightly integrate advertisements with the content of the page, more specifically the user query and search results in the case of a web search page. To more effectively select appropriate advertisements that match the user's interest and query intent, the webpage server 12 is configured to further analyze the text query 20 and generate a more sophisticated set of advertisement criteria 30. The query intent may be better categorized by defining a number of domains that model typical search scenarios. Typical scenarios may include looking for a hotel room, searching for a plane flight, shopping for a product, or similar scenarios. Alternatively, if the web page is not a web search page, the page content may be analyzed to determine the user's interest to generate the advertisement criteria 30.

The advertisement criteria 30 are provided to the advertisement engine 16. The advertisement engine 16 includes an index module 32 and a data module 34. The advertisement engine 16 performs an ad matching algorithm to identify advertisements that match the user's interest and the query intent. The advertisement engine 16 compares the advertisement criteria 30 to information in the index module 32 to determine the correlation of each index entry relative to the advertisement criteria 30 provided from the webpage server 12. The scoring of the index entries may be based on an ad matching algorithm that may consider the domain, keywords, and predicates of the advertisement criteria, as well as the bids and listings of the advertisement. The bids are requests from an advertiser to place an advertisement. These requests may typically be related domains, keywords, or a combination of domains and keywords. Each bid may have an associated bid price for each selected domain, keyword, or combination relating to the price the advertiser will pay to have the advertisement displayed. Listings provide additional specific information about the products or services being offered by the advertiser. The listing information may be compared with the predicate information in the advertisement criteria to match the advertisement with the query. An advertiser system 38 allows advertisers to edit ad text 40, bids 42, listings 44, and rules 46. The ad text 40 may include fields that incorporate, domain, general predicate, domain specific predicate, bid, listing or promotional rule information into the ad text.

The advertisement engine 16 may then generate advertisement search results 36 by ordering the index entries into a list from the highest correlating entries to the lowest correlating entries. The advertisement engine 16 may then access data entries from the data module 34 that correspond to each index entry in the list from the index module 32. Accordingly, the advertisement engine 16 may generate advertisement results 36 by merging the corresponding data entries with a list of index entries. The advertisement results 36 are then provided to the webpage server 12.

The advertisement engine 16 then retrieves supplemental information on the product or service advertised. The advertisement engine 16 may access a user server 52 to retrieve a user identification (id) such as the user login, user account number, or other identifier and any user preferences related to advertisements. The user id identifies the user account and may be provided to the user server 52 through the web page server 12. The web page server 12 may have the user login entered into the web page during an initial login sequence or alternatively the user id information may be stored on the user system 18, for example in a cookie. The advertisement results 36 may be incorporated with the supplemental information 28 and provided to the user system 18 for display to the user.

The advertisement engine 16 may request the supplemental information from the user server 52, as denoted by line 56. In addition, the user id and preference information may be supplied back to the advertisement engine 16, as denoted by line 54. The advertisement engine 16 may also use the user id to retrieve associated users from a social networking engine 58. Social networks have become very popular in the online environment. Users may log on and associate themselves with other users allowing them to exchange information and socialize. Typically, the user will establish his or her associations with other users. Sometimes the associations are mutual and one user will propose the association while the other user will confirm it. Alternatively, some networks may include unidirectional associations established by a single user. These associations may also include different classifications. For example, some users may be classified as family, others as friends, and still others as acquaintances. Other classifications may be more generic for example a simple number ranking.

The advertisement engine 16 may request the identity of other users that are associated with the current user. The advertisement engine 16 may, more specifically, only request certain classifications of associated users. Such requests are denoted by line 60. The social networking engine 58 may then provide the identity or user id of associated users to the advertisement engine, as denoted by line 62. The social networking engine may also check the user preferences of the associated users to determine if the social networking engine is permitted to disclose associated user information to generate supplemental information for advertisements. The associated user id may be further used to access information about the product or service that is related to the associated user, for example, whether the associated user clicked on the associated advertisement, whether the associated user purchased the associated product or service, as well as any rating the associated user has assigned to the advertised product or service.

The advertisement engine 16 may access the product or service related information directly from the social networking engine 58 if it is available. Alternatively, the advertisement engine 16 may access the information from the user server 52. The advertisement engine 16 may also be in communication with a 3^{rd} party database 64 that includes stored product or service information related to the associated user. Further, the advertisement engine 16 may also be in communication with the text search engine 14 (or other search engine) to search the internet or other site for product or service information related to the associated user.

The social networking engine 58 may have access to data based on the behavior (click throughs/conversions) or comments (reviews/ratings) of social network. The information calculated by the advertisement engine and displayed to the user may include:
which associated users (i.e. friends or family) that have used or reviewed this advertiser
which associated users (i.e. friends or family) own the product that is being searched for;
X associated users (i.e. friends or family) have this product, and Y associated users (i.e. friends or family) have competitor product Z;
Algorithmically derived quality measures (e.g. 1-5 stars), based on historic conversion data, bad clicks, revenue or other measures

Each of these measures may be based on supplemental information from a variety of inputs including social networks, third party databases, web searches, or related web properties.

Possible ways of getting the information from a social network include personal blogs on the social network or specialty applications within the social network (e.g. a review application). Third party database can be queried based on user intent or advertiser category. For example, the database may be used to check businesses against industry rating bodies. Further, a web index ratings/reviews/comments of particular products can be accessed from advertising sites, company sites, specialist web sites (e.g. camera review sites, consumer reports), general web sites (epinions), or personal blogs or a combination of these sites. Various information can be aggregated using sentiment classification techniques on the comments. The user server may tap sources within various related web properties (shopping/local/tech/food) using the associated user ids. Performance metrics of the ad serving system can be measured using click through rate, bad click rate or revenue generated by the advertiser.

The existing search/advertising serving infrastructure can be leveraged to match the supplemental information to a query or content. The supplemental information can be indexed much like a web document or existing listings, and matched in a similar manner.

Additions to the indexing such as product identification, sentiment classification, or ageing of old reviews could be added to enhance the system. The supplemental information can be pre-computed for global sources (e.g. general web site reviews), or computed at serve time based on evaluating parts of the index referenced by the user's social network. The supplemental information could be generated in the same system as the ad listings, or alternatively, in a separate system and then merged when all relevant processing is complete.

Supplemental information may match the query itself, the text of a sponsored or display listing, or the contents of the advertiser site. User attributes (such as location, user profile etc.) could also be used in a matching algorithm to match against available information. For example, if a user is known to be in Sunnyvale, then the local Sunnyvale better business bureau database may be used as a lookup source. There are many known algorithms for performing the matching functions required and any of these could be used for the appropriate supplemental information generation.

The supplemental information may also be incorporated directly into the advertisement listing presentation. The supplemental information is an adjunct to the basic advertiser information. There may be different approaches to displaying the supplemental information depending on its nature. In some cases, it may be decided not to show it, in other cases it may be prudent to show some supplemental information but not all. Using click or conversion feedback data, the presentation of supplemental data could be optimized by testing a variety of scenarios over a period of time and selecting the one that performs the best.

The user will notice the extra information being presented, and have more information on which to make a decision to follow through to an advertiser site. Advertisers may have concerns about content placed next to their listings. This can be mitigated in a variety of ways. For example, advertisers may select that the advertisement engine never show negative sentiments. In addition, advertisers may be given some degree of control over the types of information shown (e.g. only friend feedback). This may also generate revenue as the advertiser could pay not to have supplemental info included. Ultimately this should encourage advertisers to actively engage positive feedback, which should be good for users.

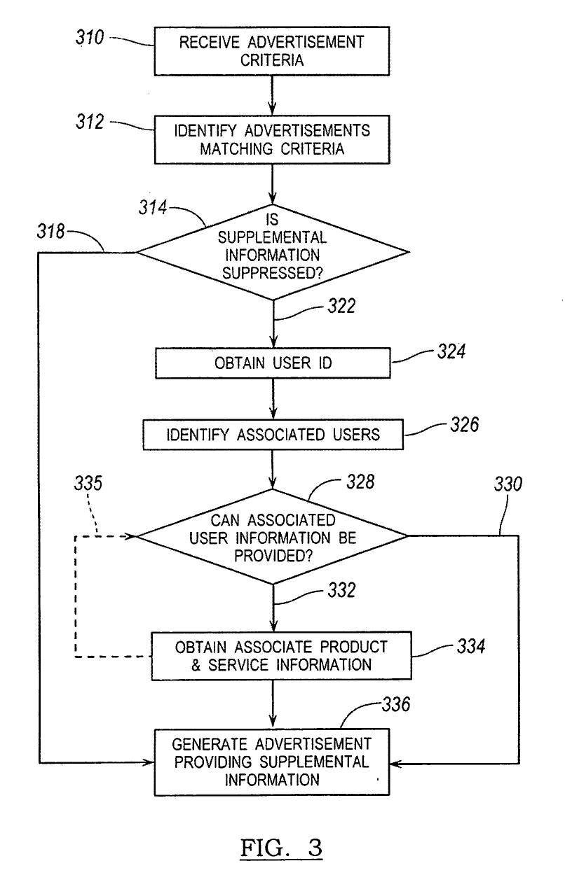

A method illustrating the another embodiment is provided in FIG. 3. The method starts in block 310, where advertisement criteria are received, for example by the advertisement engine 16. The advertisement or advertisements matching the requested criteria are identified by the advertisement engine 16, in block 312. Optionally, the advertiser may request to have the supplemental information suppressed in block 314. In addition, the current user may request to have the supplemental information suppressed. If the advertiser or current user requests to have the supplemental information suppressed in block 314, the method follows line 318 to block 336. Otherwise the method follows line 322 to block 324. In block 324, the user id is retrieved, for example from the user server 52. Associated users are identified on the basis of the user login, in block 326. The method then proceeds to block 328. If the associated user requests that the associated supplemental information not be used in the associated user preferences the method follows line 330 to block 336. Otherwise, the method follows line 332 to block 334. In block 334, supplemental information about the product or service, such as ratings, linked to the associated user is retrieved. As discussed above, such information may be retrieved from social networks, 3^{rd} party databases, web searches, or other sources. If multiple associated users are found and available for use, blocks 328 and 334 may be looped as denoted by dashed arrow 335 to check if the information may be used and retrieve information for each associated user sequentially. Finally, the advertisement is generated utilizing any available supplemental information in block 336.

Bringing more sources of information to the user when viewing ad listings, enables them to make more informed decisions about clicking on an ad. More reliable information results in more user trust and loyalty. As such, user trust and loyalty should lead to higher conversion rates for clicks.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A system for generating supplemental advertisement information, the system comprising:
an advertisement engine configured to select an advertisement from a plurality of advertisements for a web page based on advertisement criteria; and
a user server in communication with the advertisement engine, the advertisement engine being configured to receive a user identification from the user server and access supplemental information related to the advertisement based on the user identification.

2. The system according to claim 1, wherein the supplemental information is rating information about the product or service of the advertisement.

3. The system according to claim 1, wherein the advertisement engine is in communication with a social networking engine and the advertisement engine is configured to provide the user identification to the social networking engine to retrieve the supplemental information.

4. The system according to claim 3, wherein the advertisement engine is configured to retrieve at least one associated user from the social networking engine that is linked to the user identification.

5. The system according to claim 4, wherein the advertisement engine is configured to calculate a number of the at least one associated users that have clicked on the advertisement.

6. The system according to claim 5, wherein a user identification of the at least one associated users are displayed to the user along with the advertisement.

7. The system according to claim 4, wherein a number of the at least one associated users that have purchased the product or service are displayed to the user.

8. The system according to claim 4, wherein the advertisement engine is configured to determine which of the at least one associated users reviewed the advertisement.

9. The system according to claim 4, wherein the advertisement engine is configured to determine which of the at least one associated users own the product or service advertised.

10. The system according to claim 4, wherein the advertisement engine is configured to determine which of the at least one associated users own a competitor product or service.

11. The system according to claim 1, wherein the user may limit supplemental information displayed.

12. The system according to claim 1, wherein an advertiser may limit the supplemental information displayed.

13. The system according to claim 1, wherein the advertisement engine tracks performance statistics for the plurality of advertisements with and without the supplemental information.

14. The system according to claim 1, wherein the advertisement engine is configured to determine a quality measure of the supplemental information based on historic conversion data, bad clicks, or advertiser revenue.

15. The system according to claim 1, wherein the supplemental information is retrieved from a third party database.

16. The system according to claim 1, wherein the supplemental information is retrieved from a web search engine.

17. A method for generating supplemental advertisement information, the system comprising:
selecting an advertisement for a web page based on advertisement criteria;
receiving a user identification from a user server;
accessing supplemental information about the product or service in the advertisement based on the user identification; and
displaying the supplemental information to a user with the advertisement.

18. The method according to claim 17, wherein the supplemental information is rating information about the product or service of the advertisement.

19. The method according to claim 17, further comprising retrieving the supplemental information from a social networking engine based on the user identification.

20. The method according to claim 19, further comprising retrieving at least one associated user from the social networking engine that is linked to the user identification.

21. The method according to claim 20, further comprising determining a number of the at least one associated users that have clicked on the advertisement.

22. The method according to claim 21, further comprising displaying an identity of the at least one associated users along with the advertisement.

23. The method according to claim 17, further comprising determining a number of the at least one associated users that have purchased the product or service.
